(19) United States
(12) Patent Application Publication
(10) Pub. No.: US 2005/0273729 A1
(43) Pub. Date: Dec. 8, 2005

(54) Information processor and file processing method

(76) Inventor: Hiroya Kumashio, Kanagawa (JP)

Correspondence Address: DICKSTEIN SHAPIRO MORIN & OSHINSKY LLP, 2101 L Street, NW, Washington, DC, 20037, US

(21) Appl. No.: 11/138,354

(22) Filed: May 27, 2005

(30) Foreign Application Priority Data
Jun. 2, 2004 (JP) 2004-164504
Mar. 30, 2005 (JP) 2005-098561

(51) Int. Cl. G06F 3/00

(52) U.S. Cl. 715/825; 715/826

(57) ABSTRACT

An information processor is disclosed that includes a file processing part configured to provide multiple file processing functions; and a menu extension part configured to add menu items corresponding to the respective file processing functions in the file processing part to a menu displayed for a file determined as an object of manipulation in an operating system, and to request the file processing part to process the file by one of the file processing functions corresponding to a selected one of the menu items.

### BACKGROUND OF THE INVENTION

1. Field of the Invention

The present invention generally relates to information processors and file processing methods, and more particularly to an information processor and a file processing method that provide a GUI for manipulating files and to a recording medium on which a program for causing a computer to execute such a method is recorded.

2. Description of the Related Art

Conventionally, a variety of GUIs (Graphical User Interfaces) have been provided in order to reduce the work loads of manipulating files and programs on a computer as disclosed in Japanese Laid-Open Patent Application No. 2001-51841. Further, a launcher is known as application software that displays a list of previously registered files and programs with icons or buttons and enables the files and programs to be started easily by having the corresponding icons or buttons clicked with a mouse.

Users can easily find and use an objective application by registering frequently used applications with the launcher.

However, in order to use the launcher, a launcher program is required to be started in advance so as to be resident. Further, there is a problem in that part of a screen is always occupied by the panel of the launcher. There is another problem in that the residence of the launcher program wastes resources such as memory.

### SUMMARY OF THE INVENTION

Accordingly, it is a general object of the present invention to provide an information processor and a file processing method in which the above-described disadvantages are eliminated.

A more specific object of the present invention is to provide an information processor and a file processing method that make it possible to execute processing on a file with an easy operation.

Another more specific object of the present invention is to provide a recording medium on which a program for causing a computer to execute such a file processing method is recorded.

One or more of the above objects of the present invention are achieved by an information processor including: a file processing part configured to provide a plurality of file processing functions; and a menu extension part configured to add menu items corresponding to the respective file processing functions in the file processing part to a menu displayed for a file determined as an object of manipulation in an operating system, and to request the file processing part to process the file by one of the file processing functions corresponding to a selected one of the menu items.

According to the above-described information processor, a function provided by the file processing part of the information processor can be used with an easy operation through a menu.

One or more of the above objects of the present invention are also achieved by a file processing method using a computer having a file processing part providing a plurality of file processing functions, the file processing method including the steps of: (a) adding menu items corresponding to the respective file processing functions in the file processing part to a menu displayed for a file determined as an object of manipulation in an operating system; and (b) requesting the file processing part to process the file by one of the file processing functions corresponding to a selected one of the menu items.

One or more of the above objects of the present invention are also achieved by a computer-readable recording medium on which a program for causing a computer to execute a file processing method is recorded, the computer having a file processing part providing a plurality of file processing functions, the file processing method including the steps of: (a) adding menu items corresponding to the respective file processing functions in the file processing part to a menu displayed for a file determined as an object of manipulation in an operating system; and (b) requesting the file processing part to process the file by one of the file processing functions corresponding to a selected one of the menu items.

According to one aspect of the present invention, an information processor and a file processing method that make it possible to execute processing on a file with an easy operation, and a computer-readable recording medium on which a program for causing a computer to execute such a file processing method is recorded can be provided.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram illustrating a hardware configuration of an information processor according to an embodiment of the present invention;

FIG. 2 is a block diagram illustrating a functional configuration of the information processor according to the embodiment of the present invention;

FIG. 3 is a diagram illustrating an example display of a launcher panel according to the embodiment of the present invention;

FIG. 4 is a diagram illustrating a configuration of a correlation table according to the embodiment of the present invention;

FIG. 5 is a flowchart for illustrating processing executed when a file icon is right clicked according to the embodiment of the present invention;

FIG. 6 is a diagram illustrating a configuration of a file processing application list according to the embodiment of the present invention;

FIG. 7 is a diagram illustrating an example display of a context menu according to the embodiment of the present invention; and

FIG. 8 is a flowchart for illustrating processing executed when a menu item is selected according to the embodiment of the present invention.

### DETAILED DESCRIPTION OF THE PREFERRED EMBODIMENTS

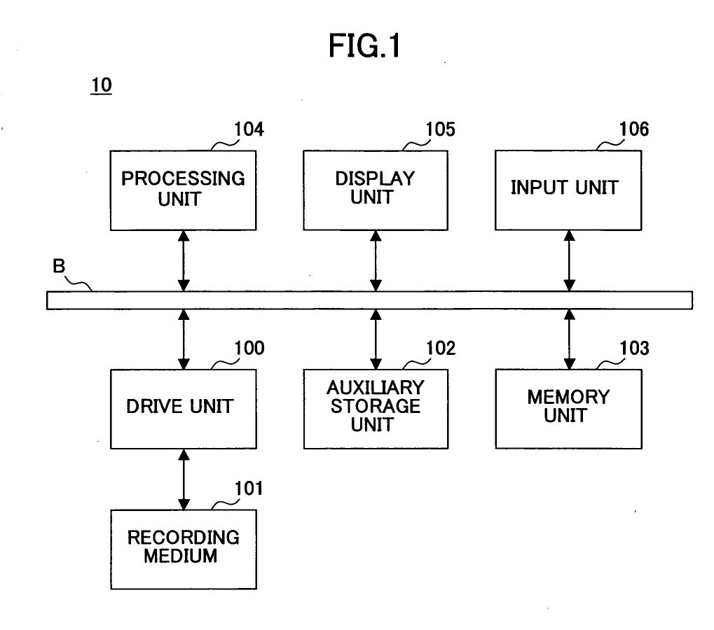

A description is given, with reference to the accompanying drawings, of an embodiment of the present invention. FIG. 1 is a block diagram illustrating a hardware configuration of an information processor 10 according to the embodiment of the present invention. The information processor 10 includes a drive unit 100, an auxiliary storage unit 102, a memory unit 103, a processing unit 104, a display unit 105, and an input unit 106, which are interconnected by a bus B.

A program used by the information processor 10 is provided by a recording medium 101 such as a CD-ROM. The recording medium 101 on which the program is recorded is set in the drive unit 100, so that the program is installed in the auxiliary storage unit 102 from the recording medium 101 through the drive unit 100. The auxiliary storage unit 102 stores the installed program as well as necessary files and data. The memory unit 103 reads out the program from the auxiliary storage unit 102 and stores the program when an instruction to start the program is given, for instance, at the time of booting the information processor 10. The processing unit 104 executes functions related to the information processor 10 in accordance with the program stored in the memory unit 103. The display unit 105 displays a GUI (Graphical User Interface) displayed by the program. The input unit 106, which includes a keyboard and a mouse, is used to input various operating instructions.

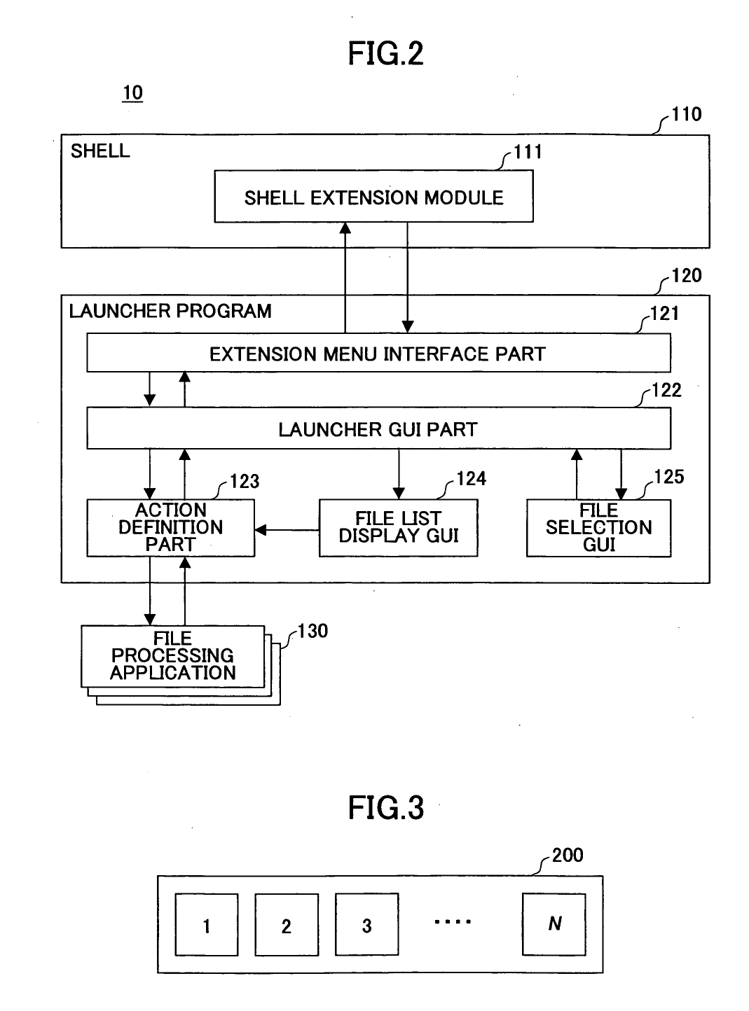

FIG. 2 is a block diagram illustrating a functional configuration of the information processor 10 according to the embodiment of the present invention. As illustrated in FIG. 2, the information processor 10 includes a shell 110 and a launcher program 120.

The launcher program 120, which is application software also generally referred to as a launcher, displays buttons for starting pre-registered functions on its screen (hereinafter referred to as “launcher panel 200”). FIG. 3 is a diagram illustrating an example display of the launcher panel 200 according to this embodiment. As illustrated in FIG. 3, multiple buttons such as BUTTON 1, BUTTON 2, BUTTON 3, . . . , BUTTON N are disposed on the launcher panel 200, and the buttons are correlated with their corresponding programs (hereinafter referred to as “file processing applications 130”). For instance, BUTTON 1 is correlated with a file printing function, BUTTON 2 is correlated with a file mail transmission function, and BUTTON 3 is correlated with a file format conversion function. The file processing applications 130, which are described as applications, are not limited to applications, and may be programs such as functions including DLL (Dynamic-Link Library).

The launcher program 120 includes an extension menu interface part 121, a launcher GUI part 122, an action definition part 123, a file list display GUI 124, and a file selection GUI 125.

The extension menu interface part 121 is a function providing an interface that makes it possible to use the function of the launcher program 120 from an external program such as a shell extension module 111 of the shell 110. For instance, the extension menu interface part 121 includes an interface for receiving a request to provide the list information of the file processing applications 130 correlated with the buttons of the launcher panel 200 and an interface for receiving requests to execute the file processing application 130.

The launcher GUI part 122 is a function for displaying the launcher panel 200 and controlling processing corresponding to an event (such as a button click) occurring on the launcher panel 200.

The action definition part 123 is a function for executing processing for starting one of the file processing applications 130 corresponding to one of the buttons disposed on the launcher panel 200 based on the correlation between the buttons on the launcher panel 200 and the corresponding file processing applications 130 when the one of the buttons is clicked. The correlation is managed by, for instance, a correlation table.

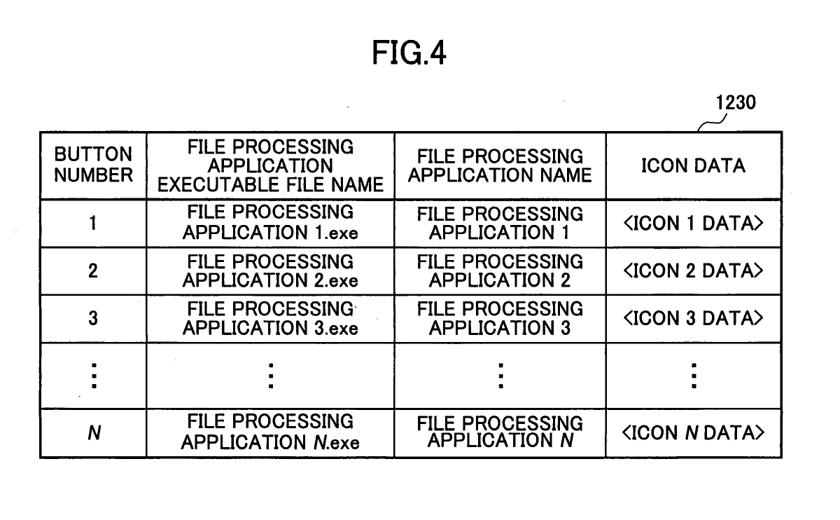

FIG. 4 is a diagram illustrating a configuration of the correlation table. As illustrated in FIG. 4, a button number, a file processing application executable file name, a file processing application name, and icon data are recorded with respect to each of the buttons on the launcher panel 200 in a correlation table 1230. The button number is assigned uniquely to each button. The file processing application executable file name is the name of the executable file of the corresponding file processing application 130. If the file processing application 130 is provided by a library such as DLL, the file name of the library corresponds to the file processing application executable file name. If the file processing application 130 is any other program, the file processing application executable file name may be identification information that is necessary for the launcher program 120 to dynamically call the program. The file processing application name is a character string to be displayed for identifying the corresponding file processing application 130. The icon data is the binary data of an icon to be displayed on the corresponding button.

Referring back to FIG. 2, each of the file list display GUI 124 and the file selection GUI 125 is a function for displaying a GUI (for instance, a file dialog) for selecting a file to be processed by the file processing application 130 corresponding to one of the buttons of the launcher panel 200 when the one of the buttons is clicked.

The shell 110 is a software module, also generally referred to as a shell, providing an interface for executing the functions of an OS (Operating System), such as file manipulation and program activation. For instance, Explorer in Windows® corresponds to the shell 110. The shell 110 includes an interface for performing function extension of the shell 110 (generally referred to as “shell extension”). The shell extension module 111 is provided in the shell 110 based on the interface.

The shell extension module 111 is a module such as DLL including a function for adding a menu item for operating the launcher program 120 to a context menu displayed by the shell 110 when a file icon is right clicked, and for requesting the launcher program 120 to execute processing corresponding to the menu item when the menu item is selected.

A brief description is given of the shell 110 and the shell extension module 111 taking Windows® as an example. When a file icon is right clicked on Explorer, the shell 110 refers to the Registry, and determines whether the shell extension module 111 is entered in a predetermined position of the Registry (whether the shell 110 is extended). If the shell extension module 111 is entered in the Registry, the shell 110 requests the shell extension module 111 to add a menu item to the context menu. This request is transmitted to the shell extension module 111 by the shell 110 calling a method (QueryContextMenu) provided in the shell extension module 111 in accordance with prespecified interface specifications. When the menu item is added to the context menu by the shell extension module 111, the shell 110 displays the context menu including the added menu item.

Further, when the menu item added by the shell extension module 111 is selected on the displayed context menu, the shell 110 calls a method (InvokeCommand) provided in the shell extension module 111 in accordance with the prespecified interface specifications, thereby requesting the shell extension module 111 to execute processing corresponding to the menu item. In response to the request from the shell 110, the shell extension module 111 executes processing provided in the InvokeCommand method.

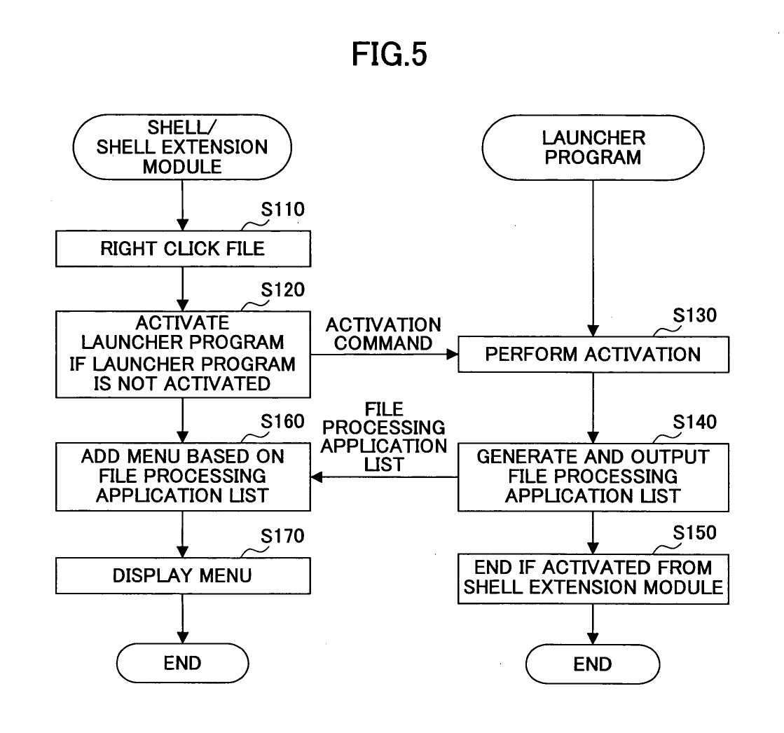

A description is given, with reference to FIG. 5, of a processing procedure of the information processor 10 of FIG. 2. FIG. 5 is a flowchart for illustrating processing executed when a file icon is right clicked.

In step S110 of FIG. 5, for instance, when a user right clicks a file icon displayed by Explorer with a mouse, this is detected by the shell 110, and the shell 110 requests the shell extension module 111 to add a menu item to the context menu. Next, in step S120, the shell extension module 111 determines whether the launcher program 120 has been activated. If the launcher program 120 has not been activated, the shell extension module 111 activates the launcher program 120 in the background. Activating the launcher program 120 in the background means to activate the launcher program 120 without displaying the GUI of the launcher program 120, that is, the launcher panel 200.

Next, in step S130, activation of the launcher program 120 in the background is performed if the launcher program 120 has not been activated. The launcher program 120 generates the correlation table 1230 when the launcher program 120 is activated. The correlation table 1230 may be created and stored in advance, but should be generated by this timing at the latest.

Next, in step S140, the extension menu interface part 121 of the launcher program 120 generates the list information of the file processing applications 130 correlated with the buttons on the launcher panel 200 (hereinafter referred to as “file processing application list) based on the correlation table 1230 in response to a request from the shell extension module 111, and outputs the file processing application list to the shell extension module 111.

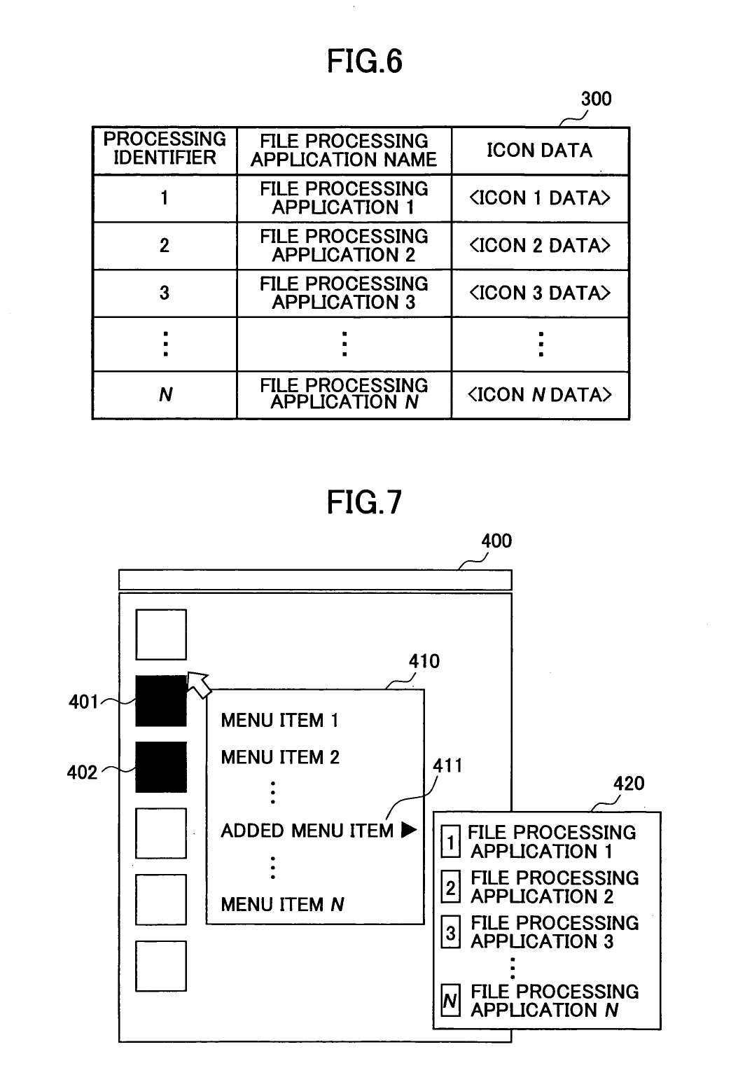

FIG. 6 is a diagram illustrating a configuration of the file processing application list. As illustrated in FIG. 6, a file processing application list 300 includes a processing identifier, a file processing application name, and icon data with respect to each of the file processing applications correlated with the corresponding buttons on the launcher panel 200, which are extracted from the correlation table 1230. The processing identifier is treated as information identifying the corresponding file processing application 130 in the file processing application list 300. According to this embodiment, the value of the corresponding button number in the correlation table 1230 is used directly as the value of the processing identifier.

If the launcher program 120 has been activated in the background from the shell extension module 111, in step S150, the launcher program 120 ends the process after the outputting of the file processing application list 300.

Receiving the file processing application list 300 from the launcher program 120, in step S160, the shell extension module 111 adds a menu item corresponding to each file processing application 130 included in the file processing application list 300 to the context menu. That is, the file processing application name and the icon data corresponding to each file processing application 130 included in the file processing application list 300 are set as a label or icon for the corresponding menu item.

Next, in step S170, the shell 110 displays the context menu to which the menu items are added by the shell extension module 111.

FIG. 7 is a diagram illustrating an example display of the context menu. For instance, FIG. 7 shows a case where file icons 401 and 402 are selected and a context menu 410 is displayed with respect to the corresponding files on a screen 400 that is a GUI displayed by the shell 110, such as Explorer in Windows®. A menu item 411 and a sub menu 420 set in the menu item 411 in the context menu 410 are menu items or a menu added by the shell extension module 111. The sub menu 420 displays menu items each displaying the file processing application name and the icon of the corresponding one of the file processing applications 130 included in the file processing application list 300.

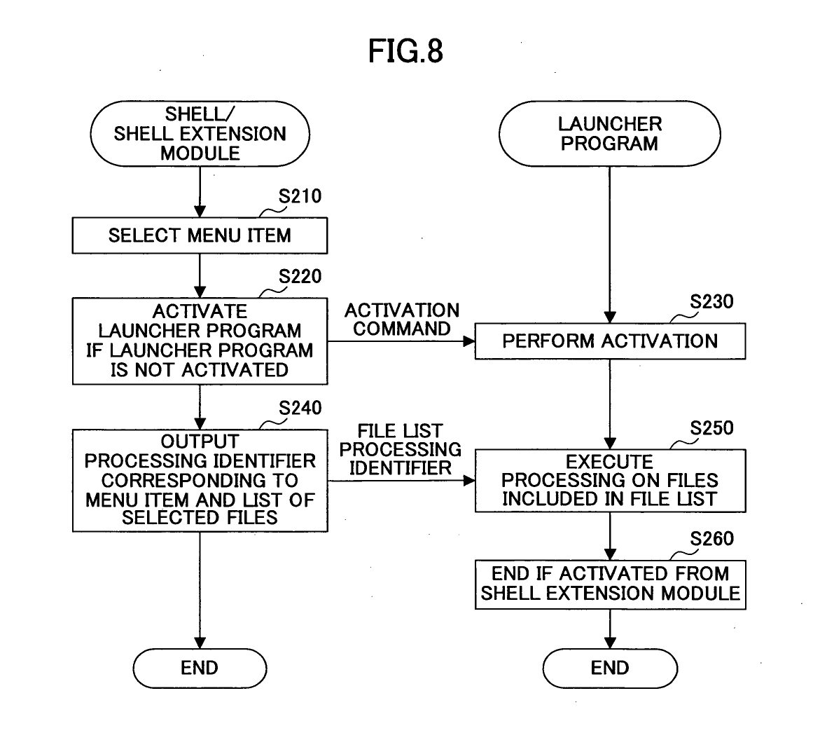

When the user selects any of the menu items in the sub menu 420, processing illustrated in FIG. 8 is executed. FIG. 8 is a flowchart for illustrating processing executed when a menu item is selected.

In step S210 of FIG. 8, when the user selects any of the menu items in the sub menu 420, this is detected by the shell 110, and the shell 110 requests the shell extension module 111 to execute processing corresponding to the selected menu item. Next, in step S220, the shell extension module 111 determines whether the launcher program 120 has been activated. If the launcher program 120 has not been activated, the shell extension module 111 activates the launcher program 120 in the background.

Next, in step S230, activation of the launcher program 120 in the background is performed if the launcher program 120 has not been activated.

Next, in step S240, the shell extension module 111, with a processing identifier corresponding to the menu item selected by the user and the list information of the files whose icons 401 and 402 are selected on the screen 400 (hereinafter referred to as “file list”), requests the launcher program 120 through the extension menu interface part 121 to execute processing corresponding to the processing identifier.

Next, in step S250, the action definition part 123 of the launcher program 120 identifies one of the file processing applications 130 to be activated from the correlation table 1230 based on the processing identifier, and executes the one of the file processing applications 130 with the files included in the file list (hereinafter referred to as “current files”) being objects of processing. Accordingly, for instance, if the one of the file processing applications 130 is a program for converting a data format, the data format of each current file is converted. Next, if the launcher program 120 has been activated in the background from the shell extension module 111, in step S260, the launcher program 120 ends the process.

As described above, according to the information processor 10 in this embodiment, the file processing applications 130 correlated with the launcher program 120 can be activated from a context menu. Accordingly, a user can cause processing on a file to be executed with an easy operation. Further, a menu item displayed in the context menu is determined dynamically based on the correlation table 1230. Accordingly, it is possible to change the display contents of the context menu dynamically based on entry of a file processing application into or deletion of any of the file processing applications 130 from the launcher program 120.

Further, the same icons as are displayed on the buttons on the launcher panel 200 are displayed for the menu items displayed in the context menu. Accordingly, a user can easily identify the file processing applications 130 correlated with the menu items.

Further, there is no need to make the process of the launcher program 120 resident, and the launcher program 120 may be activated at the time of displaying the context menu. Accordingly, it is possible to reduce consumption of resources such as memory and CPU.

The present invention is not limited to the specifically disclosed embodiment, and variations and modifications may be made without departing from the scope of the present invention.

The present application is based on Japanese Priority Patent Applications No. 2004-164504, filed on Jun. 2, 2004, and No. 2005-098561, filed on Mar. 30, 2005, the entire contents of which are hereby incorporated by reference.

1. An information processor, comprising:
a file processing part configured to provide a plurality of file processing functions; and
a menu extension part configured to add menu items corresponding to the respective file processing functions in the file processing part to a menu displayed for a file determined as an object of manipulation in an operating system, and to request the file processing part to process the file by one of the file processing functions corresponding to a selected one of the menu items.

2. The information processor as claimed in claim 1, wherein the file processing part displays an image in which components for activating the corresponding file processing functions are disposed.

3. The information processor as claimed in claim 2, wherein:
the menu extension part requests the file processing part to process the file by the one of the file processing functions corresponding to the selected one of the menu items after activating the file processing part; and
the file processing part ends the file processing part after requesting the one of the file processing functions corresponding to the selected one of the menu items to process the file.

4. The information processor as claimed in claim 3, wherein the menu extension part activates the file processing part so that the file processing part is activated without displaying the image.

5. The information processor as claimed in claim 1, wherein:
the menu extension part requests the file processing part to process the file by the one of the file processing functions corresponding to the selected one of the menu items after activating the file processing part; and
the file processing part ends the file processing part after requesting the one of the file processing functions corresponding to the selected one of the menu items to process the file.

6. The information processor as claimed in claim 1, wherein the menu extension part obtains identification information of each of the file processing functions from the file processing part, and adds the menu items to the menu based on the identification information.

7. The information processor as claimed in claim 1, wherein the menu extension part obtains a name of each of the file processing functions from the file processing part, and adds the menu items to the menu, the menu items causing the respective names to be displayed as labels.

8. The information processor as claimed in claim 1, wherein the menu extension part obtains icon data corresponding to each of the file processing functions from the file processing part, and adds the menu items to the menu, the menu items causing the respective icon data to be displayed.

9. A file processing method using a computer having a file processing part providing a plurality of file processing functions, the file processing method comprising the steps of:
(a) adding menu items corresponding to the respective file processing functions in the file processing part to a menu displayed for a file determined as an object of manipulation in an operating system; and
(b) requesting the file processing part to process the file by one of the file processing functions corresponding to a selected one of the menu items.

10. A computer-readable recording medium on which a program for causing a computer to execute a file processing method is recorded, the computer having a file processing part providing a plurality of file processing functions, the file processing method comprising the steps of:
(a) adding menu items corresponding to the respective file processing functions in the file processing part to a menu displayed for a file determined as an object of manipulation in an operating system; and
(b) requesting the file processing part to process the file by one of the file processing functions corresponding to a selected one of the menu items.
